(19) United States
(12) Patent Application Publication
(10) Pub. No.: US 2011/0153702 A1
(43) Pub. Date: Jun. 23, 2011

(54) MULTIPLICATION OF A VECTOR BY A PRODUCT OF ELEMENTARY MATRICES

(76) Inventor: Philip M. Starhill, Incline Village, NV (US)

(21) Appl. No.: 12/645,851

(22) Filed: Dec. 23, 2009

(51) Int. Cl. G06F 17/16

(52) U.S. Cl. 708/234; 708/607

(57) ABSTRACT

A method, system and computer program product to improve multiplication of a vector by a product of elementary matrices. The method includes, for example, receiving an input vector and determining, by at least one computer processor, which intermediate resultants of a matrix vector product between the input vector and a plurality of elementary matrices can be performed in parallel. At least some of the intermediate resultants may be calculated in parallel by a plurality of computer processors if they are not dependent on the pending product resultant of the input vector and one or more of the elementary matrices.

### BACKGROUND

Depending on the number of elementary matrices and the complexity of the elementary matrices and the input vector, determining the matrix vector product may be a computationally intensive and time consuming process. This operation is typically performed by multiplying the vector by each elementary matrix in turn.

### SUMMARY

An embodiment of the present invention allows multiplication of a vector by a product of elementary matrices to be parallelized. This results in faster computation of the matrix vector product as the number of processors (cores) increases. The elementary matrices are analyzed to determine the dependencies among the constituent operations, allowing independent operations to be carried out in parallel.

According to an embodiment of the invention, a system to improve multiplication of a vector by a product of elementary matrices may include at least one computer processor. The system may also include a controller configured to cause the computer processor to determine which intermediate resultants of a matrix vector product between an input vector and a plurality of elementary matrices can be performed in parallel.

The controller may further be configured to determine if each of the intermediate resultants is dependent on a pending product resultant of the input vector and one of the elementary matrices.

The system may further comprise a plurality of computer processors configured to perform the matrix vector product. The plurality of computer processors may be further configured to calculate at least some of the intermediate resultants in parallel if they are not dependent on the pending product resultant of the input vector and one or more of the elementary matrices. The plurality of computer processors may be packages in at least one multicore integrated circuit. The plurality of computer processors may further be configured to defer calculation of the intermediate resultants until they are not dependent on the pending product resultant of the input vector and one or more of the elementary matrices.

Another embodiment of the invention is a method to improve multiplication of a vector by a product of elementary matrices. The method may include receiving an input vector and determining, by at least one computer processor, which intermediate resultants of a matrix vector product between the input vector and a plurality of elementary matrices can be performed in parallel.

The method may further include determining if each of the intermediate resultants is dependent on a pending product resultant of the input vector and one of the elementary matrices. The method may additionally include calculating, by a plurality of computer processors, at least some of the intermediate resultants in parallel if they are not dependent on the pending product resultant of the input vector and one or more of the elementary matrices. The method may also include deferring, by the plurality of computer processors, calculation of the intermediate resultants until they are not dependent on the pending product resultant of the input vector and one or more of the elementary matrices.

The method may include storing an integer NUM_MATRICES containing the number of elementary matrices, an integer array SIZE of length NUM_MATRICES containing the total number of non-identity cells in each of the elementary matrices, an integer array ROWS of length NUM_MATRICES containing a row number for each of the elementary matrices, an integer NUM_NONZEROS containing the total number of non-identity cells in all the elementary matrices, an integer array COLS of length NUM_NONZEROS containing the column in which each non-identity cell appears, a floating point array VALUES of length NUM_NONZEROS containing the non-identity cell values of the elementary matrices, an integer array NEXT of length NUM_MATRICES containing the index of the next matrix from the plurality of matrices with a non-identity cell in the column whose index is equal to ROWS[i], a Boolean array DONE of length NUM_MATRICES, and an integer array WAIT of length NUM_MATRICES. The method may further include initializing all elements of the DONE array to False, initializing all elements of the WAIT array to zero, finding a first entry of DONE, having an index integer i, that is False, storing i as an integer CURRENT accessible solely by a computer processor P(j), where P(j) is one of the plurality of computer processors, incrementing WAIT[NEXT[CURRENT]] by one, setting DONE[CURRENT] to True, waiting until WAIT[CURRENT] is equal to zero, and decrementing WAIT[NEXT[CURRENT]] by one.

Another embodiment of the invention is computer program product for processing a matrix vector product. The computer program product may include computer readable program code configured to receive an input vector and determine which intermediate resultants of the matrix vector product between the input vector and a plurality of elementary matrices can be performed in parallel.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a schematic block diagram of a system to improve multiplication of a vector by a product of elementary matrices in accordance with the invention.

FIG. 2 shows three example matrices illustrating aspects of the invention.

FIG. 3 is a flowchart illustrating method aspects according to the invention.

FIG. 4 is a flowchart illustrating method aspects according to the method of FIG. 3.

FIG. 5 is a flowchart illustrating method aspects according to the method of FIG. 4.

FIG. 6 is a flowchart illustrating method aspects according to the method of FIG. 5.

### DETAILED DESCRIPTION

Embodiments of the invention will now be described more fully hereinafter with reference to the accompanying drawings, in which embodiments of the invention are shown.

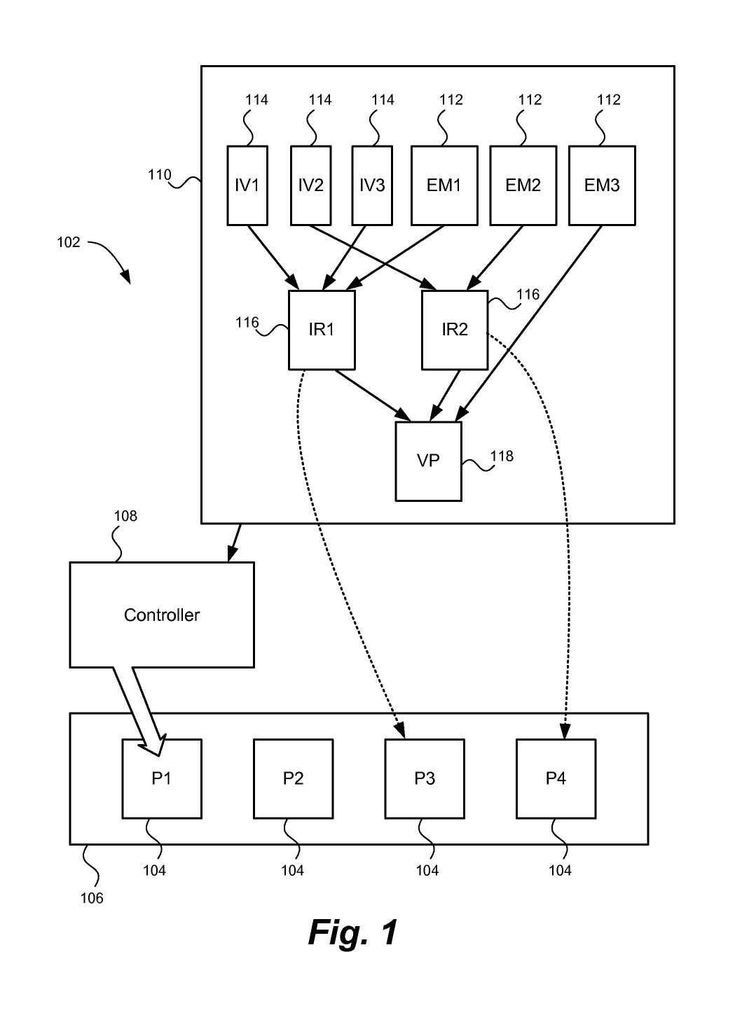

With reference now to FIG. 1, a system 102 for multiplication of a vector by a product of elementary matrices to be parallelized is initially described. In an embodiment, the system 102 includes a plurality of computer processors 104. In one embodiment, the plurality of computer processors 104 are packages in at least one multicore integrated circuit 106.

A controller 108 may execute on one of the plurality of computer processors 104. The controller 108 receives a data structure 110 representing a plurality of elementary matrices 112. The controller 108 may also receive an input vector 114. As the inventor herein has recognized, multiplying the vector by each elementary matrix in turn takes the same amount of time on multi-core processors as on single core processors. As discussed in more detail below, the controller 108 is configured to cause the computer processor 104 to determine which intermediate resultants 116 of a matrix vector product 118 between the input vectors 114 and the plurality of elementary matrices 112 can be performed in parallel by the computer processors 104.

In an embodiment of the invention, the controller 108 is configured to determine if each of the intermediate resultants 116 is dependent on a pending product resultant of the input vectors 114 and one of the elementary matrices 112. For example, the vector product VP is shown to be dependent on pending intermediate resultant IR1 and pending intermediate resultant IR2. Thus, the vector product VP cannot be calculated in parallel with either intermediate resultant IR1 or intermediate resultant IR2.

However, neither intermediate resultant IR1 nor intermediate resultant IR2 is dependent on a pending product resultant of the input vectors 114 and one of the elementary matrices 112. Thus, the controller 108 may assign computer processor P3 to compute intermediate resultant IR1 and computer processor P4 to compute intermediate resultant IR2 in parallel with each other. By computing intermediate resultants in parallel, the time required to compute the matrix vector product VP can be greatly decreased.

The computer processors 104 are configured to perform the matrix vector product. The computer processors 104 may be further configured to calculate at least some of the intermediate resultants 116 in parallel if they are not dependent on the pending product resultant of the input vector 114 and one or more of the elementary matrices 112. The computer processors 104 may be further configured to defer calculation of the intermediate resultants 116 until they are not dependent on a pending product resultant of the input vector 114 and one or more of the elementary matrices 112.

In one embodiment of the invention, the data structure that stores the elementary matrices is augmented with additional data that describes the dependencies among the operations comprising the overall matrix vector multiplication. The algorithm that executes the matrix vector multiplication uses this additional data to determine which operations can be executed immediately, and which operations must wait until the current operations have been executed.

Conventionally, a sequence of elementary matrices are stored in a data structure that contains:

a) an integer NUM_MATRICES containing the number of elementary matrices;

b) an integer array SIZE of length NUM_MATRICES containing the total number of non-identity cells in each of the elementary matrices;

c) an integer array ROWS of length NUM_MATRICES containing an elementary row number for each of the elementary matrices;

d) an integer NUM_NONZEROS containing the total number of non-identity cells in all the elementary matrices;

e) an integer array COLS of length NUM_NONZEROS containing the column in which each non-identity cell appears; and

f) a floating point array VALUES of length NUM_NONZEROS containing the non-identity cell values of the elementary matrices.

An embodiment of the present invention augments this data structure with:

g) an integer array NEXT of length NUM_MATRICES containing the index of the next matrix from the plurality of matrices with a non-identity cell in the column whose index is equal to the ROWS[i];

h) a Boolean array DONE of length NUM_MATRICES; and

i) an integer array WAIT of length NUM_MATRICES.

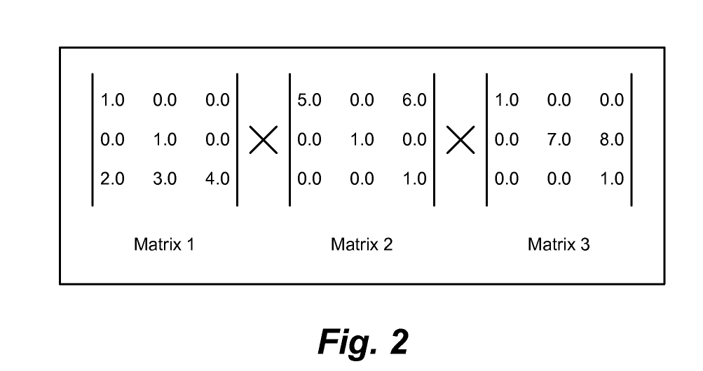

With reference now to FIG. 2, an example set of elementary matrices are shown. Because matrix multiplication is applied beginning with the rightmost matrix, the data in the arrays begins with the rightmost matrix. Thus, the product of the example elementary matrices would be stored as follows:

NUM_MATRICES=3

SIZE=[2, 2, 3]

ROWS=[2, 1, 3]

NUM_NONZEROS=7

COLS=[2, 3, 1, 3, 1, 2, 3]

VALUES=[7.0, 8.0, 5.0, 6.0, 2.0, 3.0, 4.0]

The modified data structure contemplated by an embodiment of the invention includes an additional integer array NEXT of length NUM_MATRICES. NEXT[i] stores the index of the next matrix with a nonzero in the column whose index is equal to the ROWS[i]. In the example of FIG. 2, we would have:

NEXT=[3, 3, 0]

because matrix 2 does not have a nonzero in column 2, which is the row in which matrix 1 has its non-zeros.

This tells us that when multiplying these matrices by a vector, the computation involved in applying matrix 1 (the rightmost matrix) and matrix 2 (the middle matrix) can be carried out in parallel, while the computation involved in applying matrix 3 (the leftmost matrix) depends on the result of applying both matrix 1 and matrix 2.

When computing the matrix-vector product, two additional integer arrays (WAIT and DONE) with length NUM_MATRICES may be used. These arrays are initialized so that all entries are 0. Each processing unit or computer processor will do the following:

1) Find the first entry of DONE that is 0; store it in an integer CURRENT

2) increment WAIT[NEXT[CURRENT]] by 1

3) set DONE[CURRENT] to 1

4) wait until WAIT[CURRENT] is 0

5) multiply the input vector by matrix CURRENT

6) decrement WAIT[NEXT[CURRENT]] by 1

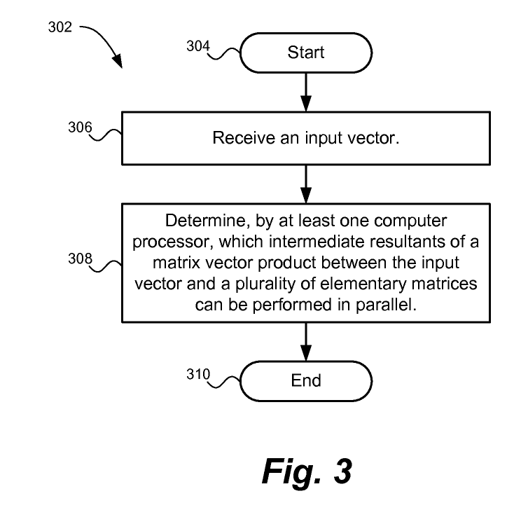

Another embodiment of the invention is a method to improve multiplication of a vector by a product of elementary matrices, which is now described with reference to flowchart 302 of FIG. 3. The method begins at Block 304 and includes receiving an input vector at Block 306. The method also includes determining, by at least one computer processor, which intermediate resultants of a matrix vector product between the input vector and a plurality of elementary matrices can be performed in parallel at Block 308. The method ends at Block 310.

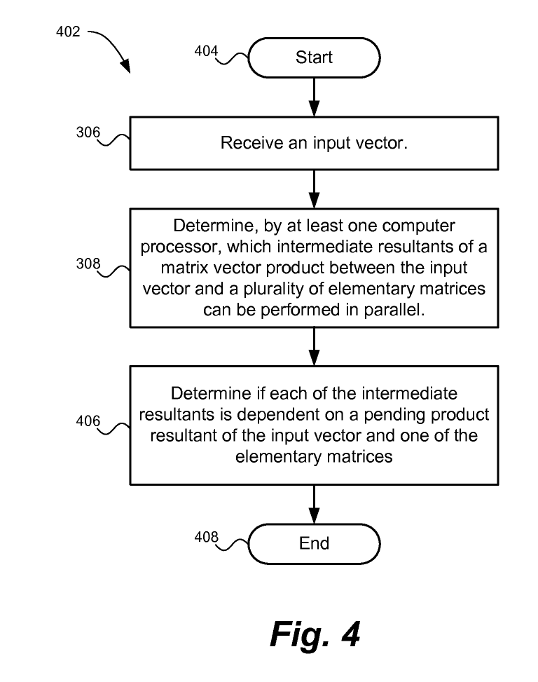

In another method embodiment, which is now described with reference to flowchart 402 of FIG. 4, the method begins at Block 404. The method may include the steps of FIG. 3 at Blocks 306 and 308. The method may additionally include determining if each of the intermediate resultants is dependent on a pending product resultant of the input vector and one of the elementary matrices at Block 406. The method ends at Block 408.

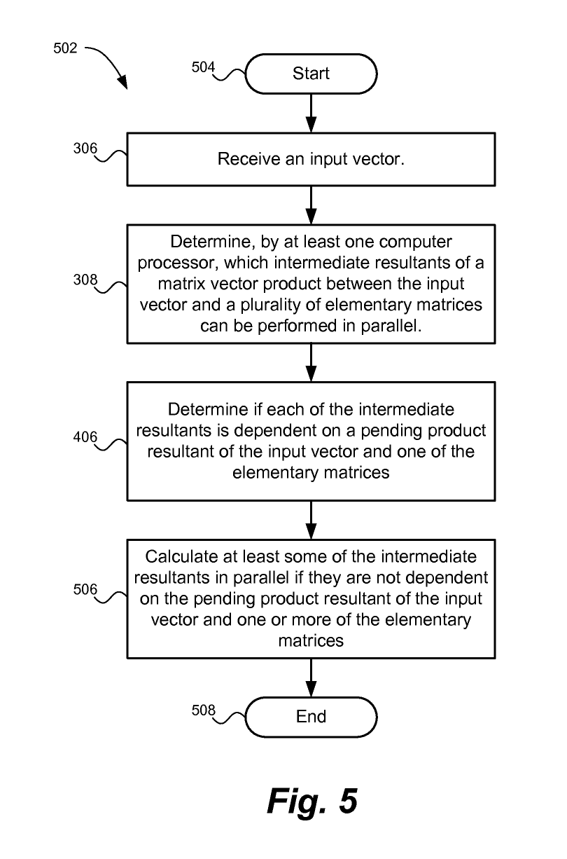

In another method embodiment, which is now described with reference to flowchart 502 of FIG. 5, the method begins at Block 504. The method may include the steps of FIGS. 3 and 4 at Blocks 306, 308 and 406. The method may additionally include calculating, by the plurality of computer processors, at least some of the intermediate resultants in parallel if they are not dependent on the pending product resultant of the input vector and one or more of the elementary matrices at Block 506. The method ends at Block 508.

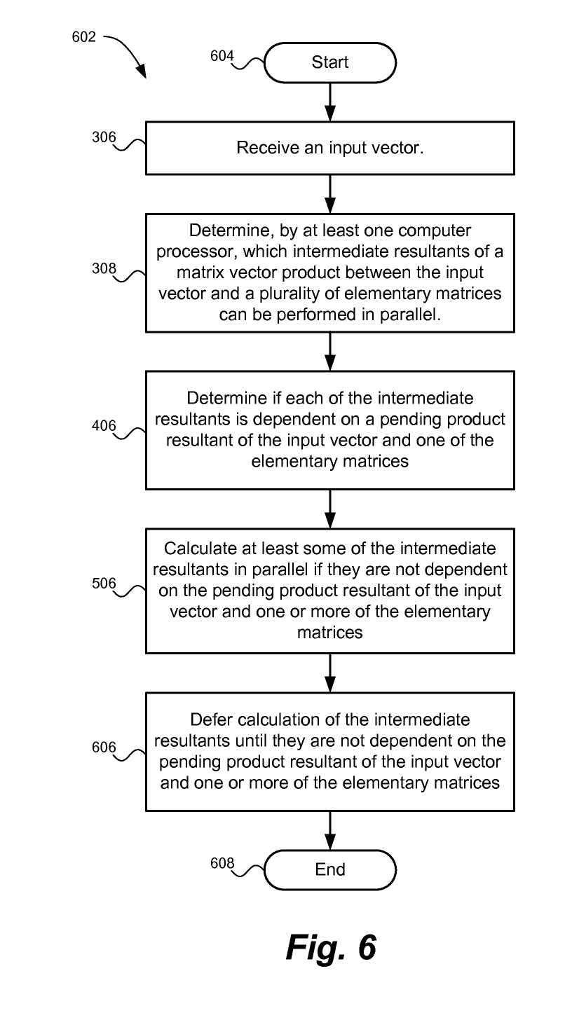

In another method embodiment, which is now described with reference to flowchart 602 of FIG. 6, the method begins at Block 604. The method may include the steps of FIGS. 3, 4 and 5 at Blocks 306, 308, 406 and 506. The method may additionally include deferring, by the plurality of computer processors, calculation of the intermediate resultants until they are not dependent on the pending product resultant of the input vector and one or more of the elementary matrices at Block 606. The method ends at Block 608.

As will be appreciated by one skilled in the art, aspects of the invention may be embodied as a system, method or computer program product. Accordingly, aspects of the invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention. Furthermore, the use of the terms a, an, etc. do not denote a limitation of quantity, but rather denote the presence of at least one of the referenced item.

While embodiments of the invention has been described, it will be understood that those skilled in the art, both now and in the future, may make various improvements and enhancements which fall within the scope of the claims which follow. These claims should be construed to maintain the proper protection for the invention first described.

What is claimed is:

1. A system comprising:
at least one computer processor; and
a controller configured to cause the computer processor to determine which intermediate resultants of a matrix vector product between an input vector and a plurality of elementary matrices can be performed in parallel.

2. The system of claim 1, wherein the controller is further configured to determine if each of the intermediate resultants is dependent on a pending product resultant of the input vector and one of the elementary matrices.

3. The system of claim 2, further comprising a plurality of computer processors configured to perform the matrix vector product.

4. The system of claim 3, wherein the plurality of computer processors are further configured to calculate at least some of the intermediate resultants in parallel if they are not dependent on the pending product resultant of the input vector and one or more of the elementary matrices.

5. The system of claim 4, wherein the plurality of computer processors are packages in at least one multicore integrated circuit.

6. The system of claim 4, wherein the plurality of computer processors are further configured to defer calculation of the intermediate resultants until they are not dependent on the pending product resultant of the input vector and one or more of the elementary matrices.

7. The system of claim 4 further comprising:
an integer NUM_MATRICES containing the number of elementary matrices;
an integer array SIZE of length NUM_MATRICES containing the total number of non-identity cells in each of the elementary matrices;
an integer array ROWS of length NUM_MATRICES containing an elementary row number for each of the elementary matrices;
an integer NUM_NONZEROS containing the total number of non-identity cells in all the elementary matrices;
an integer array COLS of length NUM_NONZEROS containing the column in which each non-identity cell appears;
a floating point array VALUES of length NUM_NONZEROS containing the non-identity cell values of the elementary matrices;
an integer array NEXT of length NUM_MATRICES containing the index of a next matrix from the plurality of matrices with a non-identity cell in the column whose index is equal to the ROWS[i];
a Boolean array DONE of length NUM_MATRICES;
an integer array WAIT of length NUM_MATRICES; and
wherein the controller is further configured to:
initialize all elements of the DONE array to False;
initialize all elements of the WAIT array to zero;
find a first entry of DONE, having an index integer i, that is False;
store i as an integer CURRENT accessible solely by a computer processor P(j), where P(j) is one of the plurality of computer processors;
increment WAIT[NEXT[CURRENT]] by one;
set DONE[CURRENT] to True;
wait until WAIT[CURRENT] is equal to zero; and
decrement WAIT[NEXT[CURRENT]] by one.

8. A method comprising:
receiving an input vector;
determining, by at least one computer processor, which intermediate resultants of a matrix vector product between the input vector and a plurality of elementary matrices can be performed in parallel.

9. The method of claim 8, further comprising determining if each of the intermediate resultants is dependent on a pending product resultant of the input vector and one of the elementary matrices.

10. The method of claim 9, further comprising calculating the matrix vector product by a plurality of computer processors.

11. The method of claim 10, further comprising calculating, by the plurality of computer processors, at least some of the intermediate resultants in parallel if they are not dependent on the pending product resultant of the input vector and one or more of the elementary matrices.

12. The method of claim 11, wherein the plurality of computer processors are packages in at least one multicore integrated circuit.

13. The method of claim 11, further comprising deferring, by the plurality of computer processors, calculation of the intermediate resultants until they are not dependent on the pending product resultant of the input vector and one or more of the elementary matrices.

14. The method of claim 11, wherein:
an integer NUM_MATRICES contains the number of elementary matrices;
an integer array SIZE of length NUM_MATRICES contains the total number of non-identity cells in each of the elementary matrices;
an integer array ROWS of length NUM_MATRICES contains an elementary row number for each of the elementary matrices;
an integer NUM_NONZEROS contains the total number of non-identity cells in all the elementary matrices;
an integer array COLS of length NUM_NONZEROS contains the column in which each non-identity cell appears;
a floating point array VALUES of length NUM_NONZEROS contains the non-identity cell values of the elementary matrices;
an integer array NEXT of length NUM_MATRICES contains the index of a next matrix from the plurality of matrices with a non-identity cell in the column whose index is equal to the ROWS[i];
a Boolean array DONE of length NUM_MATRICES; and
an integer array WAIT of length NUM_MATRICES;
the method comprising:
initializing all elements of the DONE array to False;
initializing all elements of the WAIT array to zero;
finding a first entry of DONE, having an index integer i, that is False;
storing i as an integer CURRENT accessible solely by a computer processor P(j), where P(j) is one of the plurality of computer processors;
incrementing WAIT[NEXT[CURRENT]] by one;
setting DONE[CURRENT] to True;
waiting until WAIT[CURRENT] is equal to zero; and
decrementing WAIT[NEXT[CURRENT]] by one.

15. A computer program product for processing a matrix vector product, the computer program product comprising:
a computer readable storage medium having computer readable program code embodied therewith, the computer readable program code configured to:
receive an input vector;
determine which intermediate resultants of the matrix vector product between the input vector and a plurality of elementary matrices can be performed in parallel.

16. The computer program product of claim 15, further comprising computer readable program code to determine if each of the intermediate resultants is dependent on a pending product resultant of the input vector and one or more of the elementary matrices.

17. The computer program product of claim 16, further comprising computer readable program code to calculate the matrix vector product by a plurality of computer processors.

18. The computer program product of claim 17, further comprising computer readable program code to calculate, by the plurality of computer processors, at least some of the intermediate resultants in parallel if they are not dependent on the pending product resultant of the input vector and one or more of the elementary matrices.

19. The computer program product of claim 18, further comprising computer readable program code to defer, by the plurality of computer processors, calculation of the intermediate resultants until they are not dependent on the pending product resultant of the input vector and one of the elementary matrices.

20. The computer program product of claim 19, wherein:
an integer NUM_MATRICES contains the number of elementary matrices;
an integer array SIZE of length NUM_MATRICES contains the total number of non-identity cells in each of the elementary matrices;
an integer array ROWS of length NUM_MATRICES contains an elementary row number for each of the elementary matrices;
an integer NUM_NONZEROS contains the total number of non-identity cells in all the elementary matrices;
an integer array COLS of length NUM_NONZEROS contains the column in which each non-identity cell appears;
a floating point array VALUES of length NUM_NONZEROS contains the non-identity cell values of the elementary matrices;
an integer array NEXT of length NUM_MATRICES contains the index of a next matrix from the plurality of matrices with a non-identity cell in the column whose index is equal to the ROWS[i];
a Boolean array DONE of length NUM_MATRICES; and
an integer array WAIT of length NUM_MATRICES;
the computer program product further comprising computer readable program code to:
initialize all elements of the DONE array to False;
initialize all elements of the WAIT array to zero;
find a first entry of DONE, having an index integer i, that is False;
store i as an integer CURRENT accessible solely by a computer processor P(j), where P(j) is one of the plurality of computer processors;
increment WAIT[NEXT[CURRENT]] by one;
set DONE[CURRENT] to True;
wait until WAIT[CURRENT] is equal to zero; and
decrement WAIT[NEXT[CURRENT]] by one.
